(19) United States
(12) Patent Application Publication
(10) Pub. No.: US 2012/0017039 A1
(43) Pub. Date: Jan. 19, 2012

(54) CACHING USING VIRTUAL MEMORY

(75) Inventor: Julien MARGETTS, Thame (GB)

(73) Assignee: PLX TECHNOLOGY, INC., Sunnyvale, CA (US)

(21) Appl. No.: 12/837,778

(22) Filed: Jul. 16, 2010

(51) Int. Cl. G06F 12/08; G06F 12/02

(52) U.S. Cl. 711/105; 711/118; 711/E12.007; 711/E12.017

(57) ABSTRACT

In a first embodiment of the present invention, a method for caching in a processor system having virtual memory is provided, the method comprising: monitoring slow memory in the processor system to determine frequently accessed pages; for a frequently accessed page in slow memory: copy the frequently accessed page from slow memory to a location in fast memory; and update virtual address page tables to reflect the location of the frequently accessed page in fast memory.

### BACKGROUND OF THE INVENTION

1. Field of the Invention

The present invention relates generally to computers. More specifically, the present invention relates to the caching of application code and/or data using virtual memory.

2. Description of the Related Art

Modern computer processors commonly use cache memories to speed access to frequently used instructions and/or data. These cache memories may be located on the central processing unit (CPU) itself (known as ‘on-chip’ memory), on the motherboard in external memory.

Caches can be broken up into a hierarchy of different levels. For example, the most frequently used items may be stored in a small, but very fast level 1 cache. Next most frequently used items may be stored in a larger, but not as fast level 2 cache, and so on.

External memory can be significantly slower to access than on-chip processor memory, but processor memory is often expensive. As such, it is common for processor manufacturers to include a very fast level 1 cache for instructions on the processor itself, while utilizing less expensive memory for a level 2 cache, or foregoing a level 2 cache altogether.

Using the external memory for direct storage of data and foregoing level 2 caching altogether can be costly in terms of performance, due to the aforementioned significant difference in speeds between internal and external memory. Some manufacturers choose to use a level 2 cache in on-chip memory, but this requires the presence of a full-blown level 2 cache controller, with dedicated fast memory. The level 2 cache controller adds unwanted complexity and expense to the processor, and this dedicated memory cannot be reused for non-level 2 cache applications without additional multiplexing hardware, as it is not a directly mapped memory. Additionally, with a full level 2 cache, additional dedicated RAMs are required for tag and valid information. Additional complexity is also added because of the need to maintain coherency.

What is needed is a solution that does not suffer from these issues.

### SUMMARY OF THE INVENTION

In a first embodiment of the present invention, a method for caching in a processor system having virtual memory is provided, the method comprising: monitoring slow memory in the processor system to determine frequently accessed pages; for a frequently accessed page in slow memory: copy the frequently accessed page from slow memory to a location in fast memory; and update virtual address page tables to reflect the location of the frequently accessed page in fast memory.

In a second embodiment of the present invention, a method for operating a processor contained on a microchip is provided, the method comprising: receiving a command requiring information stored in a memory page; determining if the memory page is located in a level 1 cache stored on the microchip; retrieving the memory page from the level 1 cache if the memory page is located in the level 1 cache, otherwise: accessing page tables controlled by a virtual memory management unit on the microchip, to determine a location for the memory page; retrieving the memory page from a slow memory external to the microchip if the page tables indicate that the page is located in the slow memory; and retrieving the memory page from a fast memory on the microchip if the page tables indicate that the page is located in the fast memory; continuously monitoring the slow memory to locate heavily accessed pages; and copying heavily accessed pages from the slow memory to the fast memory and updating the pages tables to reflect the locations of the heavily accessed pages in fast memory.

In a third embodiment of the present invention, a microchip is provided comprising: a processor; a virtual memory address translation unit; a first memory storing page tables controlled by the virtual memory address translation unit; a second memory storing a level 1 cache; a level 1 cache controller coupled to the second memory; a third memory comprising fast memory; a system bus interface configured to interface with a system bus connected to a fourth memory, wherein the fourth memory comprises slow memory; and wherein the virtual memory address translation unit is configured to, upon a notification of a level 1 cache miss, access the page tables in the first memory to determine if a location of a page corresponding to the level 1 cache miss is contained in the third memory or the fourth memory, and to return the corresponding location to the processor for retrieval.

In a fourth embodiment of the present invention, a program storage device readable by a machine tangibly embodying a program of instructions executable by the machine to perform a method for operating a processor contained on a microchip is provided, the method comprising: receiving a command requiring information stored in a memory page; determining if the memory page is located in a level 1 cache stored on the microchip; retrieving the memory page from the level 1 cache if the memory page is located in the level 1 cache, otherwise: accessing page tables controlled by a virtual memory management unit on the microchip, to determine a location for the memory page; retrieving the memory page from a slow memory external to the microchip if the page tables indicate the page is located in the slow memory; and retrieving the memory page from a fast memory on the microchip if the page tables indicate the page is located in the fast memory; continuously monitoring the slow memory to locate heavily accessed pages; and copying heavily accessed pages from the slow memory to the fast memory and updating the pages tables to reflect the locations of the heavily accessed pages in fast memory.

### BRIEF DESCRIPTION OF THE DRAWINGS

FIG. 1 is a diagram illustrating a caching system for a processor in accordance with an embodiment of the present invention at a first time.

FIG. 2 is a diagram illustrating a caching system for a processor in accordance with an embodiment of the present invention at a second time.

FIG. 3 is a diagram illustrating a caching system for a processor in accordance with an embodiment of the present invention at a third time.

FIG. 4 is a flow diagram illustrating a method for caching in a processor system having virtual memory in accordance with an embodiment of the present invention.

FIG. 5 is a block diagram illustrating a microchip in accordance with an embodiment of the present invention.

### DETAILED DESCRIPTION OF SPECIFIC EMBODIMENTS

Reference will now be made in detail to specific embodiments of the invention, including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, internal fast memory, such as SRAM, is utilized in a manner similar to that of a level 2 cache, but without using a dedicated level 2 cache controller or having the fast memory dedicated solely to level 2 caching. This is accomplished via the use of virtual memory addressing, along with address space utilization monitoring hardware.

The present invention works best with a processor with instruction execution access to both a fast internal memory, and a slower external memory. In normal operation, it would be expected that the code resides in slow memory. The present invention also works best in systems that have a virtual addressing scheme, with the CPU, or a separate memory management unit, that translates virtual addresses issued by the CPU into physical addresses used to access hardware and memory components of the system. Additionally, it is preferable that the address translation be made via the use of page tables, and that the page size is such that at least one full page can fit within the fast internal memory. In general, it is even more preferable if several pages, such as between 8 and 256, can fit within the fast internal memory. It is also preferable for there to be a method to determine, at runtime, the number of level 1 instruction cache line fetches that occur to a given physical page of slow memory, and safely modify them to reference the faster memory. These are preferable circumstances for the operation of the present invention, but are not mandatory.

In an embodiment of the present invention, a process is implemented in hardware, run as a separate software process, or run as a task on the main processor, for example. The process may act to continuously update the area of fast memory, operating it as a pseudo-cache without incurring all of the drawbacks of a full-blown level 2 cache. This process may perform several acts. First, it may monitor and count level 1 instruction cache line fills from data contained within pages of the slow physical memory. It may also then monitor and count level 1 instruction cache line fills from data contained within pages of the fast physical memory (in the beginning these will be zero as there is no code in the fast RAM at startup). This information can then be sorted so that the most heavily accessed pages in the slow memory can be determined. Then, periodically, a decision can be made as to whether it would be beneficial to evict any existing fast memory pages and replace them with pages from the slow memory. For example, if the line fill count for a given page in slow RAM is greater than that of one of the page slots in the fast memory, by some predetermined margin, the fast memory page can be replaced in fast memory with the slow memory page. For pages to be evicted, the address translation tables may be remapped so that the virtual page table entries pointing to the evicted page point back to the slow memory. Likewise, for pages being copied from the slow memory into the fast memory, the address translation tables may be remapped so that the virtual page table entries pointing to the newly added page point to the fast memory instead of the slow memory. This process can be repeated indefinitely to provide for a dynamic environment where pages are added to, or removed from, fast memory and the tables are updated automatically when circumstances so dictate.

The inventive process described herein appears to work better with static data, such as Linux kernel code, than for dynamic data. This is because the tasks become considerably more complex if the application code space is being dynamically changed, which can occur when, for example, user space applications are being loaded and unloaded at run-time. Thus, in an embodiment of the present invention, the processes described herein are limited to static data, while dynamic data is handled using traditional routines. However, one of ordinary skill in the art will recognize that the inventive processes described herein could still be applied to dynamic data as well, should the designer so choose.

In an embodiment of the present invention, a single counter that can count line fills from a programmable address range can be utilized, and programmed to monitor one page at a time. This can be used to step through all of the pages in the address range of interest and then monitor them sequentially.

Additionally, as discussed above, the internal fast memory should at least be as large as a single page. In some embodiments of the present invention, the number of pages of fast memory is around 4 times the number that would fit in a level 1 instruction cache.

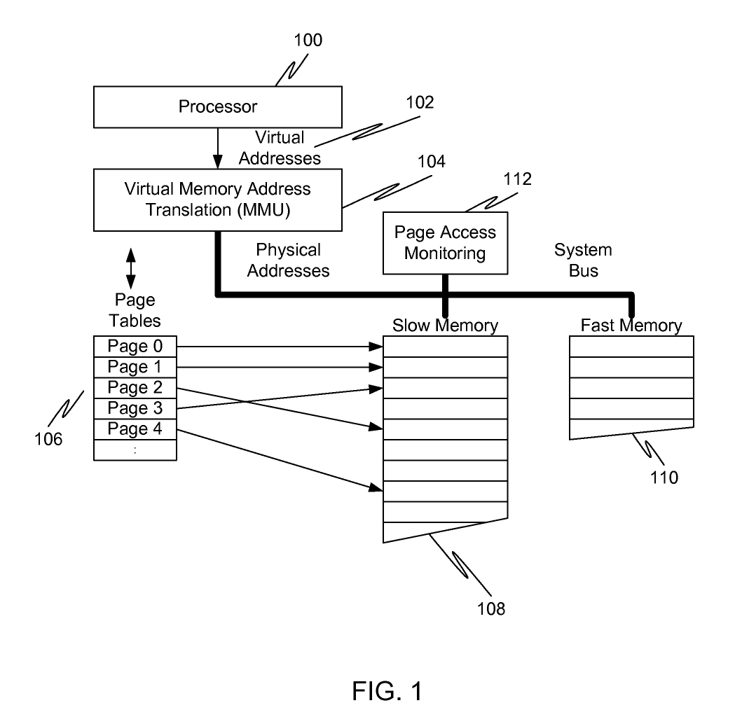

FIG. 1 is a diagram illustrating a caching system for a processor in accordance with an embodiment of the present invention at a first time. Here, processor 100 issues commands based on virtual addresses 102, which are sent to a virtual memory address translation memory management unit (MMU) 104. The MMU 104 translates the virtual addresses into physical addresses, and maintains page tables 106. At this point, all relevant data is stored in slow memory 108, so page tables 106 all point to locations in slow memory 108. Fast memory 110 is empty at this point, or at least there are no caching entries located in fast memory 110 (the memory could be used for other purposes).

A page access monitoring module 112 then can monitor the slow memory 108 and count up accesses to the various pages, over a predetermined period of time. For example, in one embodiment, the number of accesses per second are estimated by counting accesses over a shorter period. The number of accesses may then be compared for the various pages, to determine the most frequently accessed pages.

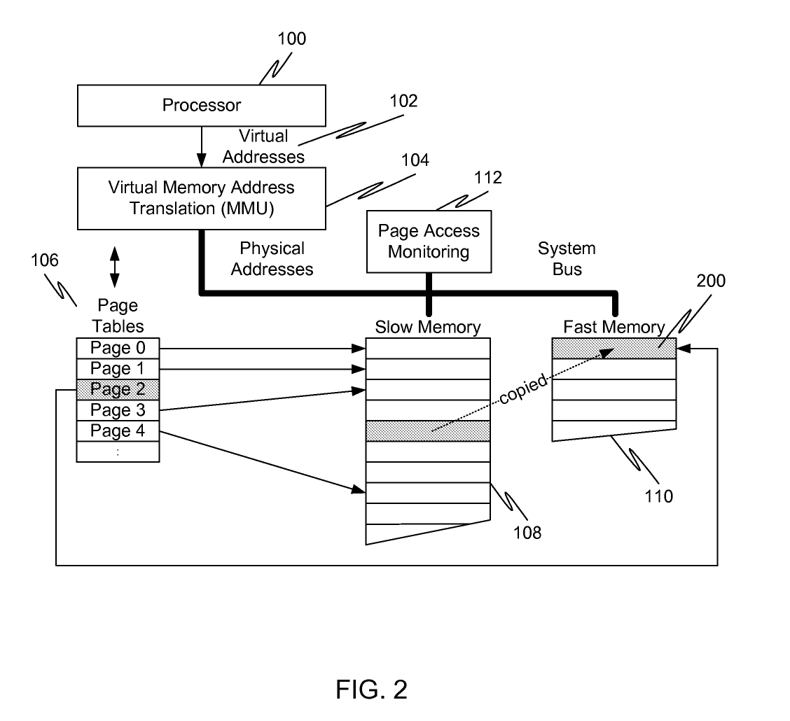

FIG. 2 is a diagram illustrating a caching system for a processor in accordance with an embodiment of the present invention at a second time. Here, processor 100 still issues commands based on virtual addresses 102, which are sent to the MMU 104. Again, the MMU still translates the virtual addresses into physical addresses. However, in this example, one of the pages in slow memory 108 has been identified by the page access monitoring module 112 as a heavily used page, and has been copied into fast memory 110. The physical address mapping of this page has been modified in the page tables 106 to point to the new location 200. The MMU 104 is informed of the change to the page tables, and subsequent accesses to this particular page are then processed much faster. Note that it is not necessary at this stage for the original content to be removed from slow memory. Embodiments are foreseen wherein the original content is left in slow memory even after copying to fast memory.

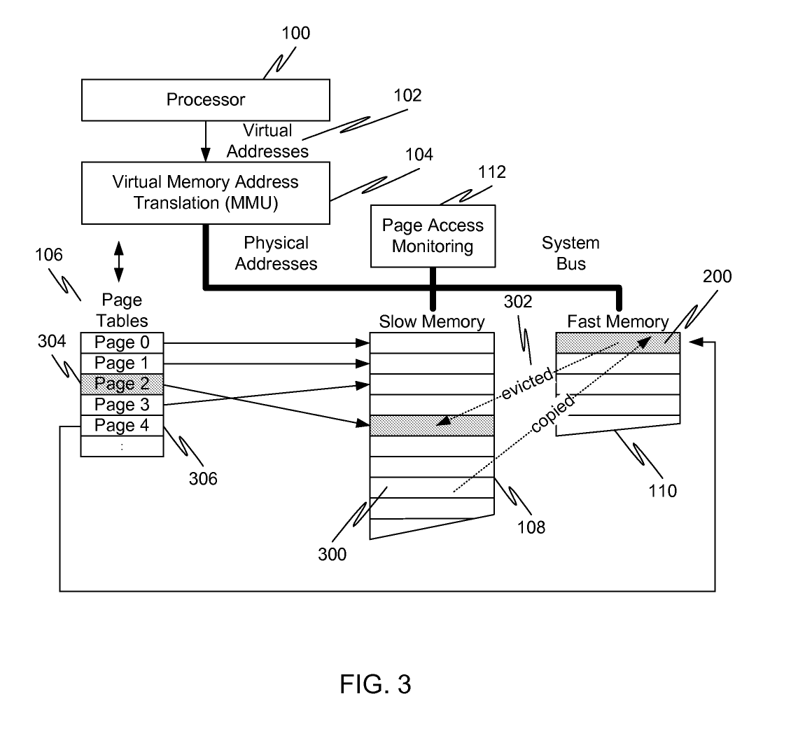

FIG. 3 is a diagram illustrating a caching system for a processor in accordance with an embodiment of the present invention at a third time. Here, suppose page 2, which was contained in fast memory 110 in FIG. 2 above, has not been used in a long time, whereas “page 4” 300 has suddenly become heavily used, such that the system decides that it would be more beneficial to have “page 4” 300 in the fast memory 110 than page 2. All of this may have been determined by the page access monitoring module 112. Page 2 is evicted 302 from fast memory 110, and its corresponding page table entry 304 is updated to reflect its new location in slow memory 108. Note that it is not necessary during this “eviction” for the original content to be copied from fast memory to slow memory as the original is still retained in slow memory. “Page 4” 300, on the other hand, is copied from slow memory 108 to fast memory 110 and its corresponding page table entry 306 is updated to reflect its new location in fast memory 110.

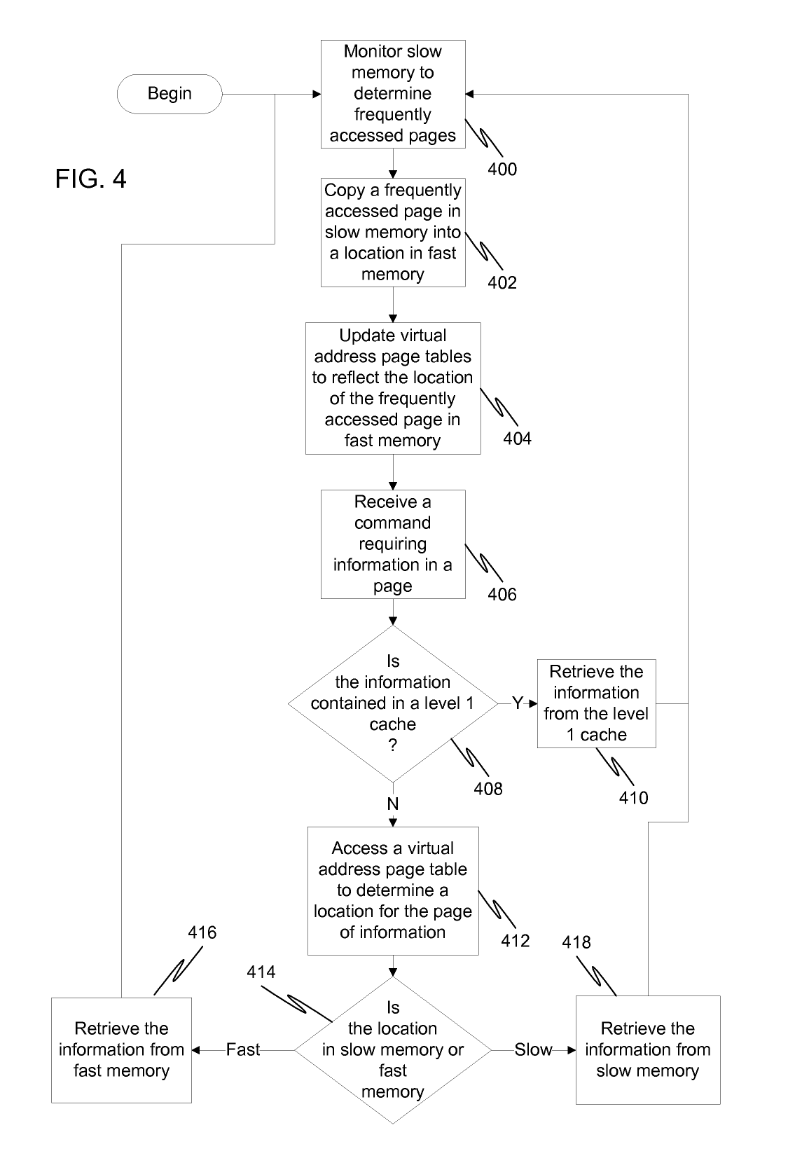

FIG. 4 is a flow diagram illustrating a method for caching in a processor system having virtual memory in accordance with an embodiment of the present invention. At 400, slow memory is monitored to determine frequently accessed pages. At 402, a frequently accessed page in slow memory is copied into a location in fast memory. At 404, virtual address page tables are updated to reflect the location of the frequently accessed page in fast memory. The slow memory can be DRAM while the fast memory can be SRAM.

At 406, a command is received requiring information stored in a memory page. At 408, it is determined if the information is contained in a level 1 cache. If so, then at 410 the information can be retrieved from the level 1 cache. If not, then at 412, a virtual address page table is accessed to determine a location for the memory page. At 414, it is determined if the virtual address page table indicates if the location is in slow memory or fast memory. If it is in fast memory, then at 416 the information is retrieved from fast memory. If it is in slow memory, then at 418 the information is retrieved from slow memory.

It should be noted that the monitoring and updating aspects of 400-404 may be performed continuously, and may be interspersed among the other steps of the method, despite their depiction in FIG. 4 as coming before the remaining method steps. The monitoring may include repeatedly scanning cache lines corresponding to a predetermined range of addresses in slow memory sequentially. A page may be determined to be frequently accessed based upon the number of accesses counted for the page during a predetermined period of time.

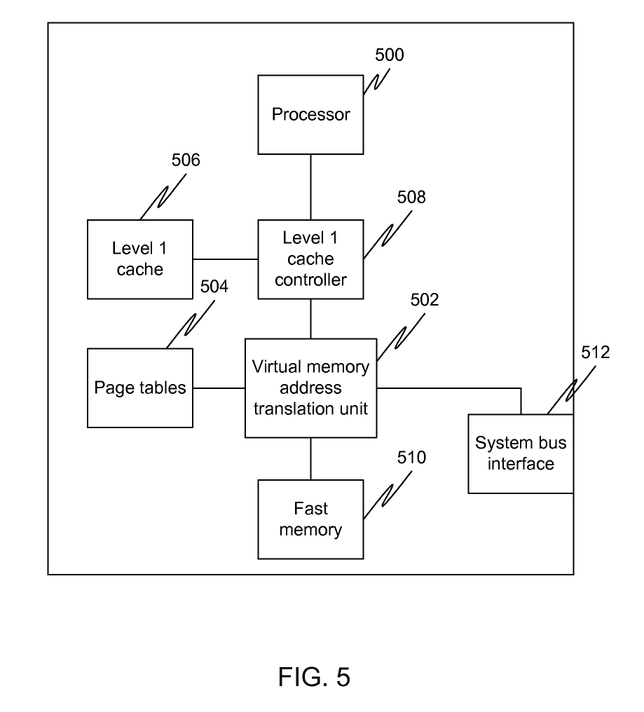

FIG. 5 is a block diagram illustrating a microchip in accordance with an embodiment of the present invention. It should be noted that this is only one embodiment of a microchip in accordance with the present invention, and one of ordinary skill in the art will recognize that other embodiments are possible.

The microchip contains a processor 500, a virtual memory address translation unit 502, and a first memory 504. The first memory 504 is used for storing page tables controlled by the virtual memory address translation unit 502. The microchip may also contain a second memory 506 used as a level 1 cache, and a corresponding level 1 cache controller 508 may control this memory 506. The microchip may also contain a third memory 510, which is fast memory.

It should be noted that while the three memories 504, 506, 510 are described and depicted as separate memories, in some embodiments of the present invention, two or more of these memories may be a single shared memory.

The microchip may also contain a system bus interface 512. The system bus interface 512 is configured to interface with a system bus (not pictured), which itself is connected to a fourth memory (not pictured) which constitutes external slow memory.

The virtual memory address translation unit 502 is configured to, upon notification of a level 1 cache miss, access the page tables in the first memory to determine if a location of a page corresponding to the level 1 cache miss is contained in the third memory or the fourth memory, and to return the corresponding location to the processor for retrieval.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for caching in a processor system having virtual memory, the method comprising:
monitoring slow memory in the processor system to determine frequently accessed pages;
for a frequently accessed page in slow memory:
copying the frequently accessed page from slow memory to a location in fast memory; and
updating virtual address page tables to reflect the location of the frequently accessed page in fast memory.

2. The method of claim 1, wherein the slow memory is Dynamic Random Access Memory (DRAM).

3. The method of claim 1, wherein the fast memory is Static Random Access Memory (SRAM).

4. The method of claim 1, further comprising:
receiving a command requiring information;
determining if the information is contained in a level 1 cache;
if the information is not contained in the level 1 cache:
accessing a virtual address page table to determine a physical location for the information;
retrieving the information from slow memory if the location for the information indicates it is in slow memory; and
retrieving the information from fast memory if the location for the information indicates it is in fast memory.

5. The method of claim 1, wherein the monitoring includes repeatedly scanning pages of memory corresponding to a predetermined range of addresses in slow memory sequentially.

6. The method of claim 1, wherein a page is determined to be frequently accessed based upon the number of accesses counted for the page during a predetermined period of time.

7. A method for operating a processor contained on a microchip, the method comprising:
receiving a command requiring information stored in a memory page;
determining if the information is located in a level 1 cache stored on the microchip;
retrieving the information from the level 1 cache if the information is located in the level 1 cache, otherwise:
accessing page tables controlled by a virtual memory management unit on the microchip, to determine a location for the memory page;
retrieving the information from a slow memory external to the microchip if the page tables indicate that the memory page is located in the slow memory; and
retrieving the information from a fast memory on the microchip if the page tables indicate that the page is located in the fast memory;
continuously monitoring the slow memory to locate heavily accessed pages; and
copying heavily accessed pages from the slow memory to the fast memory and updating the pages tables to reflect the locations of the heavily accessed pages in fast memory.

8. The method of claim 7, wherein the method is performed in hardware.

9. The method of claim 7, wherein the method is performed as a software process separate from the processor.

10. The method of claim 7, wherein the method is performed as a task of the processor.

11. The method of claim 7, wherein the continuously monitoring and copying heavily accessed pages includes only copying heavily accessed static pages while leaving heavily accessed dynamic pages untouched.

12. A microchip comprising:
a processor;
a virtual memory address translation unit;
a first memory storing page tables controlled by the virtual memory address translation unit;
a second memory storing a level 1 cache;
a third memory comprising fast memory;
a system bus interface configured to interface with a system bus connected to a fourth memory, wherein the fourth memory comprises slow memory; and
wherein the virtual memory address translation unit is configured to, upon a notification of a level 1 cache miss, access the page tables in the first memory to determine if a location of a page corresponding to the level 1 cache miss is contained in the third memory or the fourth memory, and to return the corresponding location to the processor for retrieval.

13. The microchip of claim 12, wherein the third memory is four times as large as the second cache.

14. The microchip of claim 12, wherein the third memory is large enough to fit at least eight pages.

15. A program storage device readable by a machine tangibly embodying a program of instructions executable by the machine to perform a method for operating a processor contained on a microchip, the method comprising:
receiving a command requiring information stored in a memory page;
determining if the information is located in a level 1 cache stored on the microchip;
retrieving the information from the level 1 cache if the information is located in the level 1 cache, otherwise:
accessing page tables controlled by a virtual memory management unit on the microchip, to determine a location for the memory page;
retrieving the information from a slow memory external to the microchip if the page tables indicate the memory page is located in the slow memory; and
retrieving the information from a fast memory on the microchip if the page tables indicate the page is located in the fast memory;
continuously monitoring the slow memory to locate heavily accessed pages; and
copying heavily accessed pages from the slow memory to the fast memory and updating the pages tables to reflect the locations of the heavily accessed pages in fast memory.

16. The program storage device of claim 15, wherein the continuously monitoring and copying heavily accessed pages includes only copying heavily accessed static pages while leaving heavily accessed dynamic pages untouched.

17. The program storage device of claim 15, wherein the continuously monitoring includes repeatedly scanning cache lines corresponding to a predetermined range of addresses in slow memory sequentially.

18. The program storage device of claim 15, wherein a page is determined to be frequently accessed based upon the number of accesses counted for the page during a predetermined period of time.

19. The program storage device of claim 15, wherein the slow memory is Dynamic Random Access Memory (DRAM).

20. The program storage device of claim 15, wherein the fast memory is Static Random Access Memory (SRAM).
